(19) United States
(12) Patent Application Publication
(10) Pub. No.: US 2009/0065996 A1
(43) Pub. Date: Mar. 12, 2009

(54) Device for cutting firewood

(76) Inventors: Anthony Coca, Pueblo, CO (US); Gina Garcia, Pueblo, CO (US)

Correspondence Address: JAMES RAY & ASSOCIATES, 2640 PITCAIRN ROAD, MONROEVILLE, PA, 15146, US

(21) Appl. No.: 12/283,153

(22) Filed: Sep. 10, 2008

Related U.S. Application Data
(60) Provisional application No. 60/993,164, filed on Sep. 10, 2007.

(51) Int. Cl. B23Q 3/00

(52) U.S. Cl. 269/296

(57) ABSTRACT

An apparatus for assisting in cutting firewood from logs, such apparatus comprises a first member having a base member and three substantially parallel legs extending outwardly. There is a second member substantially identical to such first member. The legs of the second member engage corresponding legs of the first member thereby forming a sawbuck with a V-shaped area in the sawbuck for placing logs to be cut. Clevis pins are used to secure such first member to such second member and there is a chain that is engageable with each outer pair of legs of the apparatus for preventing such apparatus from extending beyond a predetermined distance.

### CROSS REFERENCE TO RELATED APPLICATIONS

This application is closely related to and claims benefit from U.S. Provisional Application Ser. No. 60/993,164 filed Sep. 10, 2007.

### FIELD OF THE INVENTION

The present invention relates, in general, to firewood, and, more particularly, the present invention relates to a device for securing multiple logs at waist level for assisting in cutting such logs into firewood.

### BACKGROUND OF THE INVENTION

Cutting large branches into firelogs suitable for burning in a fireplace can be a time-consuming and arduous task. Typically the log is lying on the ground, requiring the individual to bend over to make the cuts with a chainsaw. Generally only one piece of wood is cut at a time, since there is no safe way to collect the logs in order to make a single cut through all the pieces to be cut. All this effort can be painful and exhausting.

Thus, it would be advantageous if there were a simple and effective means of securing multiple logs enabling the individual to cut them into firewood quickly and easily.

### SUMMARY OF THE INVENTION

In a first aspect the present invention provides an apparatus for assisting in cutting firewood. The apparatus comprises a first member made of a first predetermined material, such first member includes a base member and three substantially parallel legs engageable on a first end with such base member and extending outward therefrom. There is a second member made of a second predetermined material, such second member being substantially identical to such first member and includes a base member and three substantially parallel legs engageable on a first end with such base member and extending outward therefrom, the substantially parallel three legs of the second member are engageable with corresponding substantially parallel three legs of the first member at a point intermediate the base member and a second end of the three legs thereby forming a sawbuck having a V-shaped area in the sawbuck for placing logs to be cut into firewood. There is a first means that is engageable with each pair of legs of the three substantially parallel legs of the first member and the second member for releasably securing such first member to such second member at a point intermediate the base member and the second end of such three legs and a second means is engageable with each outer pair of legs of the apparatus at a point intermediate the base member and the first means for preventing such apparatus from extending beyond a predetermined distance when logs are placed on the V-shaped portion of the apparatus.

### OBJECTS OF THE INVENTION

It is, therefore, one of the primary objects of the present invention to provide an apparatus that will enable the user to cut multiple logs simultaneously into firewood.

Another object of the present invention is to provide an apparatus that enables the user to cut logs into firewood wherein such logs are disposed at waist level.

Still another object of the present invention is to provide an apparatus that enables the user to cut logs into firewood that is made of tubular steel.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a top perspective view of the apparatus showing the apparatus formed square tubular members.

FIG. 2 is a is a perspective view of the apparatus showing the apparatus formed with round tubular members.

FIG. 3 is a front perspective view of the apparatus in a folded up condition for storage.

FIG. 4 is a side perspective view of the apparatus shown in FIG. 2 wherein such apparatus has logs disposed thereon for cutting.

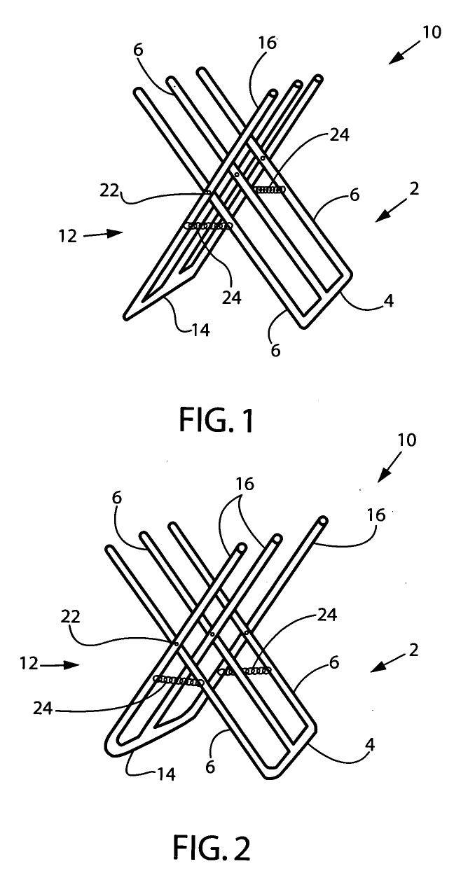

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for assisting in cutting logs into firewood. The apparatus 10 comprises a first member 2 made of a first predetermined material, such first member includes a base member 4 and three substantially parallel legs 6 engageable on a first end with such base member 2 and extending outward therefrom. There is a second member 12 made of a second predetermined material, such second member 12 being substantially identical to such first member 2 and includes a base member 14 and three substantially parallel legs 16 engageable on a first end with such base member 14 and extending outward therefrom, the substantially parallel three legs 16 of the second member 12 are engageable with corresponding substantially parallel three legs 6 of the first member 2 at a point intermediate the base member 4,14 and a second end of the three legs 6,16 thereby forming a sawbuck having a V-shaped area in the sawbuck for placing logs to be cut into firewood. There is a first means 20 that is engageable with each pair of legs 6,16 of the three substantially parallel legs 6,16 of the first member 2 and the second member 12 for releasably securing such first member 2 to such second member 12 at a point intermediate the base member 4,14 and the second end of such three legs 6,16 and a second means 30 is engageable with each outer pair of legs 6,16 of the apparatus 10 at a point intermediate the base member 2,12 and the first means 20 for preventing such apparatus 10 from extending beyond a predetermined distance when logs are placed on the V-shaped portion of the apparatus 10.

It is presently preferred that such first means 20 includes clevis pins 22 and that such second means 20 includes one of a bracket and a chain 24. A chain 24 is a preferred embodiment.

Each end of the chain 24 is secured to a corresponding leg 6, 16 intermediate the base member 4,14 and the second end of first member 2 and the second member 12 by a clevis pin 22.

It should be noted as seen in FIG. 4 that the apparatus 10 when not in use folds up for easy storage. The apparatus 10 in a folded state is approximately 36 inches wide, 50 inches high and has a thickness of approximately 3 inches.

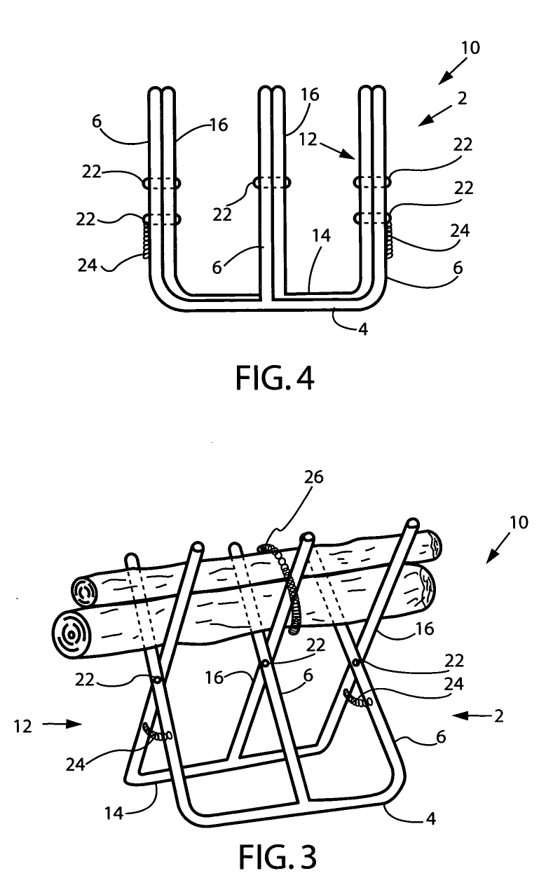

Further, as seen in FIG. 3 that such apparatus 10 will hold a plurality of logs which can be cut into firewood simultaneously. Such apparatus 10 will hold up to 600 pounds of logs at one time. Although FIG. 3 shows only two logs the unit can hold considerably more logs at one time. Further, although FIG. 3 shows the logs just extending a short distance from the end of the apparatus 10 the apparatus can house considerable longer logs whereby the user starts cutting from the end of the logs and working in toward the center of the apparatus 10.

It is also presently preferred that such first predetermined material for making such first member 2 is steel and is further preferred that such steel is a tubular steel. Such tubular steel can be either square or round. It should further be noted that such second predetermined material is substantially identical to the first predetermined material.

Such tubular steel is between about 1 inch and about 1½ inches in at least one of a length and width if it is a square tubular product or a diameter if the tubular steel is round.

Such apparatus 10 further includes a safety chain 26 for securing such logs placed in the apparatus 10 prior to cutting which can be used if desired.

Thus, the present invention provides an apparatus that will secure multiple logs at waist level enabling an individual to cut them into firewood quickly and easily. The apparatus is constructed of steel or other similar durable materials. It is capable of holding up to 600 pounds of logs at a time. The apparatus is approximately 33 to 36 inches wide and about 48 to 50 inches high and about 3 inches deep when in the folded state. The apparatus is easy to use, it is simply unfolded to create a triangular area to house the logs to be cut. In an open state it measures approximately 26 inches wide at the top and about 34 inches wide at the base. If desired, there is a safety chain provided for encircling the logs prior to being cut. The user simply works by cutting the ends first and working toward the center, efficiently slicing through the wood with a chainsaw. Since multiple logs are stacked in the unit The user only makes a single cut to produce multiple firewood sized logs. In less than a minute a considerable quantity of firewood is produced. In one cutting 103 pieces of firewood was produced in 95 seconds. This efficient process makes woodcutting a simple task rather than a dreaded chore. After cutting firewood the apparatus is simply folded up and stored.

The unit can be made in different sizes. It is made with either round or square tubing that can be 1 inch, 1¼ inch, 1⅜ inch or 1½ inches in diameter, if round, or on each side if square. The unit made from 1 inch tubing would weigh about 20 pounds. The larger ones would weigh 22 pounds, 24 pounds and 30 pounds respectively. The setting for the unit is adjustable by use of the 12 inch chains.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for assisting in cutting firewood, said apparatus comprising:
(a) a first member made of a first predetermined material, said first member including;
(i) a base member;
(ii) three substantially parallel legs engageable on a first end with said base member and extending outward therefrom;
(b) a second member made of a second predetermined material, said second member being substantially identical to said first member and including:
(i) a base member;
(ii) three substantially parallel legs engageable on a first end with said base member and extending outward therefrom, said substantially parallel three legs of said second member engageable with corresponding said substantially parallel three legs of said first member at a point intermediate said base member and a second end of said three legs thereby forming a sawbuck having a V-shaped area in said sawbuck for placing logs to be cut into firewood;
(c) a first means engageable with each pair of legs of said three substantially parallel legs of said first member and said second member for releasably securing said first member to said second member at said point intermediate said base member and said second end of said three legs; and
(d) a second means engageable with each outer pair of legs of said apparatus at a point intermediate said base member and said first means for preventing such apparatus from extending beyond a predetermined distance.

2. The apparatus, according to claim 1, wherein said first means includes clevis pins.

3. The apparatus, according to claim 1, wherein said second means includes one of a bracket and a chain.

4. The apparatus, according to claim 3, wherein said second means is a chain.

5. The apparatus, according to claim 4, wherein each end of said chain is secured to a corresponding leg intermediate said base member and said second end of said first member and said second member by a clevis pin.

6. The apparatus, according to claim 1, wherein said apparatus when not in use folds up for easy storage.

7. The apparatus, according to claim 6, wherein said apparatus in a folded state is approximately 36 inches wide, 50 inches high and has a thickness of approximately 3 inches.

8. The apparatus, according to claim 1, wherein said apparatus will hold a plurality of logs which can be cut into firewood simultaneously.

9. The apparatus, according to claim 8, wherein said apparatus will hold up to 600 pounds of logs at one time.

10. The apparatus, according to claim 1, wherein said first predetermined material is steel.

11. The apparatus, according to claim 10, wherein said steel is a tubular steel.

12. The apparatus, according to claim 11, wherein said tubular steel is selected from one of square and round.

13. The apparatus, according to claim 10, wherein said second predetermined material is substantially identical to said first predetermined material.

14. The apparatus, according to claim 11, wherein said tubular steel is between about 1 inch and about 1½ inches in at least one of a length, width and a diameter.

15. The apparatus, according to claim 1, wherein said apparatus further includes a safety chain for securing such logs placed in said apparatus prior to cutting.
